(19) United States
(12) Patent Application Publication
(10) Pub. No.: US 2005/0278476 A1
(43) Pub. Date: Dec. 15, 2005

(54) Method, apparatus and program storage device for keeping track of writes in progress on multiple controllers during resynchronization of RAID stripes on failover

(75) Inventors: John Thomas Teske, Oronoco, MN (US); Jeffrey L. Williams, Rochester, MN (US)

Correspondence Address: Crawford Maunu PLLC;Suite 390, 1270 Northland Drive, St. Paul, MN, 55120, US

(73) Assignee: XIOtech Corporation

(21) Appl. No.: 10/865,339

(22) Filed: Jun. 10, 2004

(51) Int. Cl. G06F 12/00

(52) U.S. Cl. 711/100

(57) ABSTRACT

A method, apparatus and program storage device for keeping track of writes in progress on multiple controllers during resynchronization of RAID stripes on failover is disclosed. Quicker and more efficient RAID 5 resynchronization is provided by mirroring writes that are in progress to alternate controller. When the controller handling the writes fails, the writes in progress are the only blocks that need to be resynchronized. Thus, consistent parity may be generated without resynchronizing the entire RAID.

### BACKGROUND OF THE INVENTION

1. Field of the Invention

This invention relates in general to redundant computer storage systems, and more particularly to a method, apparatus and program storage device for keeping track of writes in progress on multiple controllers during resynchronization of RAID stripes on failover.

2. Description of Related Art

Effective data storage is a critical concern in enterprise computing environments, and many organizations are employing RAID technology in server-attached, networked, and Internet storage applications to enhance data availability. Understanding how intelligent RAID technology works can enable IT managers to take advantage of the key performance and operating characteristics that RAID-5 controllers and arrays provide—especially the I/O processor subsystem, which frees the host CPU from interim read-modify-write interrupts. In addition, intelligent RAID boosts performance using exclusive OR (XOR) operations that are not available in RAID-0 and RAID-1.

The most common RAID implementations are host-based, hardware-assisted, and intelligent RAID. Host-based RAID, sometimes called software RAID, does not require special hardware. It runs on the host CPU and uses native drive interconnect technology. The disadvantage of host-based RAID is the reduction in the server's application-processing bandwidth, because the host CPU must devote cycles to RAID operations—including XOR calculations, data mapping, and interrupt processing.

Hardware-assisted RAID combines a drive interconnect protocol chip with a hardware application-specific integrated circuit (ASIC), which typically performs XOR operations. Hardware-assisted RAID is essentially an accelerated host-based solution, because the actual RAID application still executes on the host CPU, which can limit overall server performance.

Intelligent RAID creates a RAID subsystem that is separate from the host CPU. The RAID application and XOR calculations execute on a separate I/O processor. Intelligent RAID implementations cause fewer host interrupts because they off-load RAID processing from the host CPU.

There are numerous RAID techniques. Briefly, a RAID 0 employs striping, or distributing data across the multiple disks of an array of disks by striping. No redundancy of information is provided but data transfer capacity and maximum I/O rates are very high. In RAID level 1, data redundancy is obtained by storing exact copies on mirrored pairs of drives. RAID 1 uses twice as many drives as RAID 0, has a better data transfer rate for read but about the same for write as to a single disk.

In RAID 2, data is striped at the bit level. Multiple error correcting disks (Data protected by a Hamming code) provide redundancy, a high data transfer capacity for both read and write, but because multiple additional disk drives are necessary for implementation, not a commercially implemented RAID level.

In RAID level 3: Each data sector is subdivided and the data is striped, usually at the byte level across the disk drives, and one drive is set aside for parity information. Redundant information is stored on a dedicated parity disk. Very high data transfer, read/write I/O. In RAID level 4, data is striped in blocks, and one drive is set aside for parity information. In RAID 5, data and parity information is striped in Blocks and is rotated among all drives on the array.

The two most popular RAID techniques employ either a mirrored array of disks or striped data array of disks. A RAID that is mirrored presents very reliable virtual disks whose aggregate capacity is equal to that of the smallest of its member disks and whose performance is usually measurably better than that of single member disk for reads and slightly lower for writes.

A striped array presents virtual disks whose aggregate capacity is approximately the sum of the capacities of its members, and whose read and write performance are both very high. The data reliability of a striped array's virtual disks, however, is less than that of the least reliable member disk.

Disk arrays may enhance some or all of three desirable storage properties compared to individual disks. For example, disk arrays may improve I/O performance by balancing the I/O load evenly across the disks. Striped arrays have this property, because they cause streams of either sequential or random I/O requests to be divided approximately evenly across the disks in the set. In many cases, a mirrored array can also improve read performance because each of its members can process a separate read request simultaneously, thereby reducing the average read queue length in a bus system.

Disk arrays may also improve data reliability by replicating data so that it not destroyed or inaccessible if the disk on which it is stored fail. Mirrored arrays have this property, because they cause every block of data to be replicated on all members of the set. Striped arrays, on the other hand do not, because as a practical matter, the failure of one disk in a striped array renders all the data stored on the array virtual disks inaccessible.

Further, disk arrays may simplify storage management by treating more storage capacity as a single manageable entity. A system manager who managing arrays of four disks (each array presenting a single virtual disk) has one fourth as many directories to create, one fourth as many user disk space quotas to set, one fourth as many backup operations to schedule etc. Striped arrays have this property, while mirrored arrays generally do not.

More specifically, RAID 5 uses a technique (1) that writes a block of data across several disks (i.e. striping), (2) calculates an error correction code (ECC, i.e. parity) at the bit level from this data and stores the code on another disk, and (3) in the event of a single disk failure, uses the data on the working drives and the calculated code to “Interpolate” what the missing data should be (i.e. rebuilds or reconstructs the missing data from the existing data and the calculated parity). A RAID 5 array “rotates” data and parity among all the drives on the array, in contrast with RAID 3 or 4 which stores all calculated parity values on one particular drive.

A write hole can occur when a system crashes or there is a power loss with multiple writes outstanding to a device or member disk drive. One write may have completed but not all of them, resulting in inconsistent parity. For example, in a storage system having each RAID owned by only one controller, if that controller fails in the middle of a RAID 5 write, then the parity is inconsistent and data may be corrupted. If the stripe is rebuilt when a controller dies, the RAIDs owned by that controller must be guaranteed to be consistent. This requires resynchronization, wherein data is XORed to produce new consistent parity. However, resynchronization in this manner is a slow process.

It can be seen then that there is need for a method, apparatus and program storage device for providing quicker and more efficient RAID 5 resynchronization.

### SUMMARY OF THE INVENTION

To overcome the limitations described above, and to overcome other limitations that will become apparent upon reading and understanding the present specification, the present invention discloses a method, apparatus and program storage device for keeping track of writes in progress on multiple controllers during resynchronization of RAID stripes on failover.

The present invention solves the above-described problems by providing quicker and more efficient RAID 5 resynchronization by mirroring writes that are in progress to alternate controller. When the controller handling the writes fails, the writes in progress are the only blocks that need to be resynchronized. Thus, consistent parity may be generated without resynchronizing the entire RAID.

A method in accordance with the principles of the present invention includes handling writes to a stripe in storage devices arranged at least in part in a RAID 5 configuration using a first controller, mirroring the writes to a second controller during the writing to storage devices by the first controller and resynchronizing only writes in progress when the first controller fails.

In another embodiment of the present invention, a storage system is provided. The storage system includes a first controller, a second controller and at least one storage subsystem, the storage subsystem having at least a portion configured in a RAID 5 configuration, wherein the first controller handles a write operation to a stripe in the at least one storage subsystem and the second controller mirrors the write operation during the writing to the at least one storage subsystem by the first controller and the second controller, when the first controller fails, resynchronizes only writes in progress.

In another embodiment of the present invention, a controller is provided. The controller includes memory for storing data therein and a processor, coupled to the memory, for processing data, the processor mirrors write operations to at least one storage subsystem by another controller, the processor, when the other controller fails, resynchronizes only writes in progress.

In another embodiment of the present invention, a program storage device is provided. The program storage device includes program instructions executable by a processing device to perform operations for minimizing time for resynchronizing RAID stripes on failover, the operations include handling writes to a stripe in storage devices arranged at least in part in a RAID 5 configuration using a first controller, mirroring the writes to a second controller during the writing to storage devices by the first controller and resynchronizing only writes in progress when the first controller fails.

In another embodiment of the present invention, another storage system is provided. This storage system includes first means for controlling operations of at least one storage subsystem, second means for controlling operations of at least one storage subsystem and at least one storage subsystem, the storage subsystem having at least a portion configured in a RAID 5 configuration, wherein the first means handles a write operation to a stripe in the at least one storage subsystem and the second means mirrors the write operation during the writing to the at least one storage subsystem by the first means and the second means, when the first means fails, resynchronizes only writes in progress.

In another embodiment of the present invention, another controller is provided. This controller includes means for storing data and means, coupled to the means for storing data, for processing data, the means for processing data mirroring write operations to at least one storage subsystem by another means for processing, the means for processing when the other means for processing fails, resynchronizes only writes in progress.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a RAID 5 storage system according to an embodiment of the present invention;

FIG. 2 illustrates a RAID 5 storage system with arbitrary data values according to an embodiment of the present invention;

FIG. 3 shows a typical read-modify-write operation for a RAID 5 storage system according to an embodiment of the present invention;

FIG. 4 illustrates the writing of new data;

FIG. 5 illustrates a method for providing quicker and more efficient RAID 5 resynchronization according to an embodiment of the present invention;

FIG. 6 illustrates a storage system having multiple controllers and RAIDs according to an embodiment of the present invention; and

FIG. 7 illustrates a controller for keeping track of writes in progress on multiple controllers during resynchronization of RAID stripes on failover according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, apparatus and program storage device for keeping track of writes in progress on multiple controllers during resynchronization of RAID stripes on failover. Quicker and more efficient RAID 5 resynchronization is provided by mirroring writes that are in progress to alternate controller. When the controller handling the writes fails, the writes in progress are the only blocks that need to be resynchronized. Thus, consistent parity may be generated without resynchronizing the entire RAID.

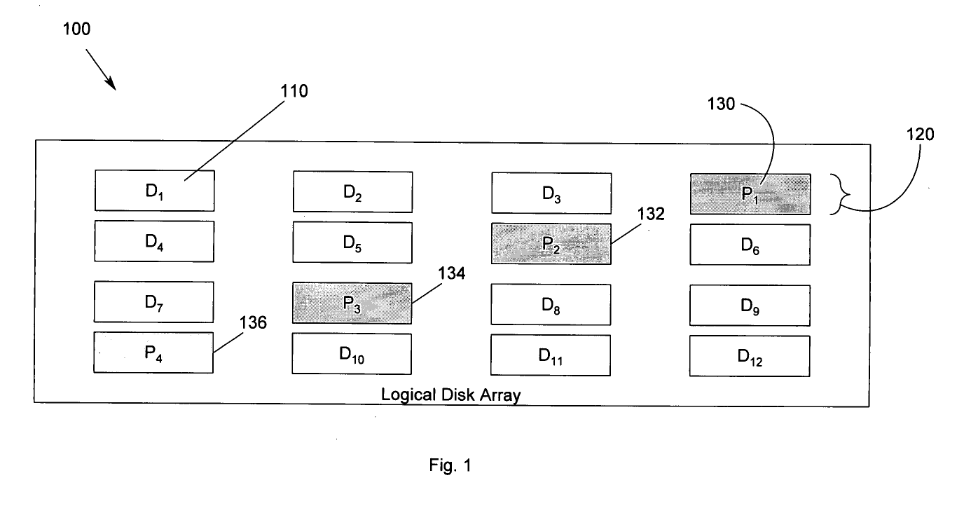

FIG. 1 illustrates a RAID 5 storage system 100 according to an embodiment of the present invention. In FIG. 1, each Dₙ 110 represents a segment of data, often referred to as a strip. All of the strips across a row are referred to as a stripe 120. In RAID-5, parity data 130, 132, 134, 136 is located in a different strip within the stripe, a concept called parity rotation. Implemented for performance reasons, parity rotation introduces a data element that represents the parity data: Pₙ, where n is the stripe number for which the parity data is stored. Parity data is simply the result of an XOR operation on all strips within the stripe, e.g., P₁ is the result of an XOR operation on D₁, D₂ and D₃. Because XOR is an associative and commutative operation, administrators can find the XOR result of multiple operands by first performing the XOR operation on any two operands—then performing an XOR operation on the result with the next operand, and continuing to perform the XOR operation on all the operands until the final result is determined.

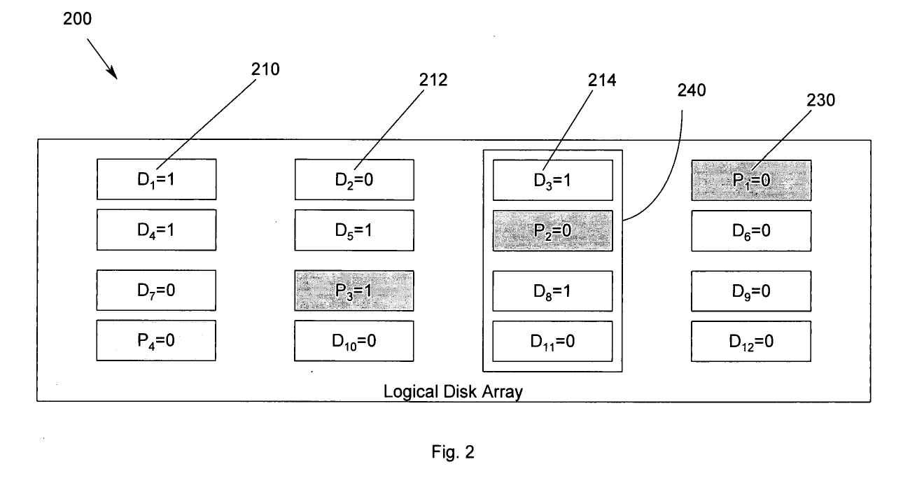

FIG. 2 illustrates a RAID 5 storage system with arbitrary data values 200 according to an embodiment of the present invention. A RAID-5 volume can tolerate the failure of any one disk without losing data. Typically, when a physical disk fails, such as physical disk 3 240 in FIG. 2 , the disk array is considered degraded. The missing data for any stripe is easily determined by performing an XOR operation on all the remaining data elements for that stripe, e.g., D₃ may be determined by performing an XOR operation on D₁, D₂ and P₁. In live implementations, each data element would represent the total amount of data in a strip. Typical values currently range from 32 KB to 128 KB. In the RAID 5 storage system 200 of FIG. 2, each element or strip 210 represents a single bit. Parity for the first stripe is P₁=D₁ XOR D₂ XOR D₃. The XOR result of D₁ (1) and D₂ (0) is 1, and the XOR result of 1 and D₃ (1) is 0. Thus P₁ is 0.

If a host requests a RAID controller to retrieve data from a disk array that is in a degraded state, the RAID controller must first read all the other data elements on the stripe, including the parity data element. It then performs all the XOR calculations before it returns the data that would have resided on the failed disk. The host is not aware that a disk has failed, and array access continues. However, if a second disk fails, the entire logical array will fail and the host will no longer have access to the data.

Most RAID controllers will rebuild the array automatically if a spare disk is available, returning the array to normal. In addition, most RAID applications include applets or system management hooks that notify system administrators when such a failure occurs. This notification allows administrators to rectify the problem before another disk fails and the entire array goes down.

The RAID-5 write operation is responsible for generating parity data. This function is typically referred to as a read-modify-write operation. Consider a stripe composed of three strips of data 210, 212, 214 and one strip of parity 230. Suppose the host wants to change just a small amount of data that takes up the space on only one strip within the stripe. The RAID controller cannot simply write that small portion of data and consider the request complete. It also must update the parity data, P₁ 230, which is calculated by performing XOR operations on every strip within the stripe, i.e., D₁ XOR D₂ XOR D₃. So parity must be recalculated when one or more strips 210, 212 or 214 changes.

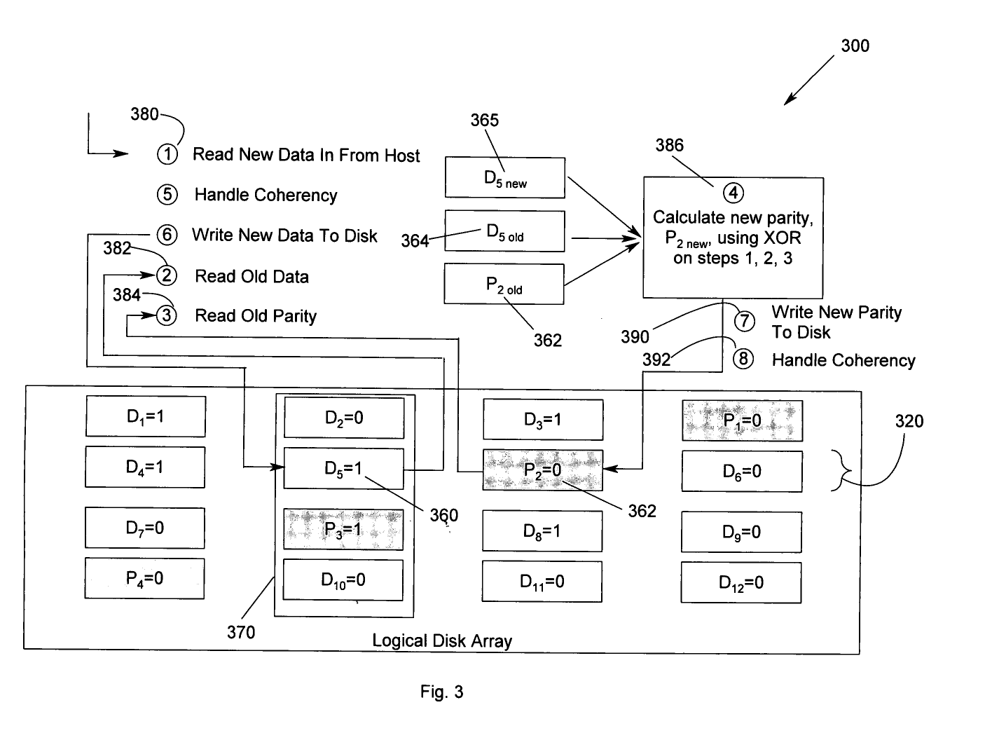

FIG. 3 shows a typical read-modify-write operation for a RAID 5 storage system 300 according to an embodiment of the present invention. In FIG. 3, the data that the host is writing to disk is contained within just one strip, in position D₅ 360. First 380, the host operating system requests that the RAID subsystem write a piece of data to location D₅ 360 on disk 2 370. Second 382, old data from disk 2 370 is read. Third 384, old parity 362 is read from the target stripe for new data. Fourth 386, new parity is calculated using the old data 364 and the new data 365. Fifth 388, for the disk array to be considered coherent, or “clean,” the subsystem must ensure that the parity data block 362 is always current for the data on the stripe. Because it is not possible to guarantee that the new target data 365 and the new parity will be written to separate disks at exactly the same instant, the RAID subsystem must identify the stripe 320 being processed as inconsistent, or “dirty,” in RAID vernacular.

The RAID mappings determine on which physical disk 370, and where on the disk 360, the new data will be written 390. The new parity is written to disk 362. Once the RAID subsystem verifies that steps have been completed successfully-and the data and parity are both on the disk, the stripe is considered coherent 392.

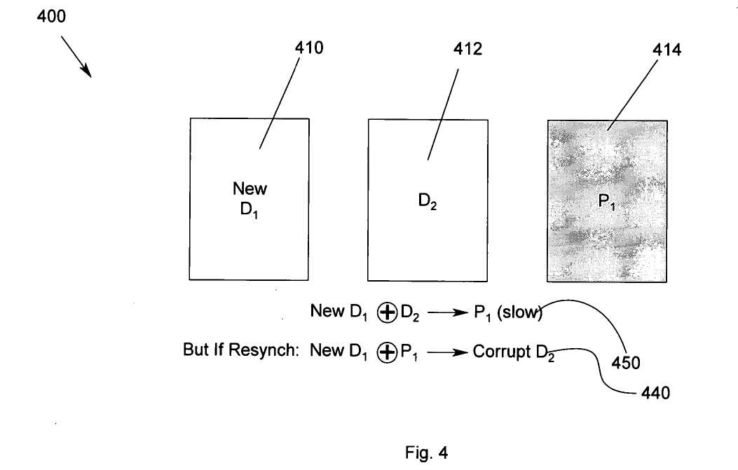

FIG. 4 illustrates the writing of new data 400. FIG. 4 shows new data, New D₁ 410, D₂ 412 and parity data, P₁ 414. If the controller for this RAID fails in the middle of a RAID 5 write, then the parity 414 is inconsistent and data may be corrupted if the stripe is rebuilt using the existing parity 414, i.e., New D1 is XORed with old parity to produce D2. However, D2 would be corrupt because parity is inconsistent 440. A resynchronization may be performed so that data is XORed to produce new consistent parity, but this process is very slow 450.

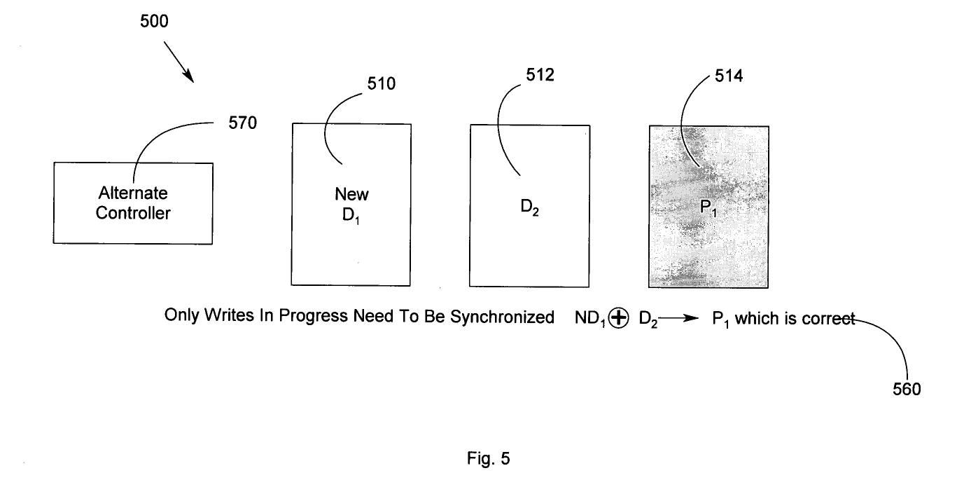

FIG. 5 illustrates a method for providing quicker and more efficient RAID 5 resynchronization 500 according to an embodiment of the present invention. FIG. 5 shows new data, New D₁ 510, D₂ 512 and parity data, P₁ 514. To accelerate resynchronization, the writes that are in progress are mirrored to alternate controller 570. Alternate controller 570 is coupled to the controller (not shown) for D₁ 510, D₂ 512 and P₁ 514. When the controller for D₁ 510, D₂ 512 and P₁ 514 fails, the writes in progress are the only blocks that need to be resynchronized 560. Thus, consistent parity may be generated. This process is very fast compared to resynchronizing the entire RAID.

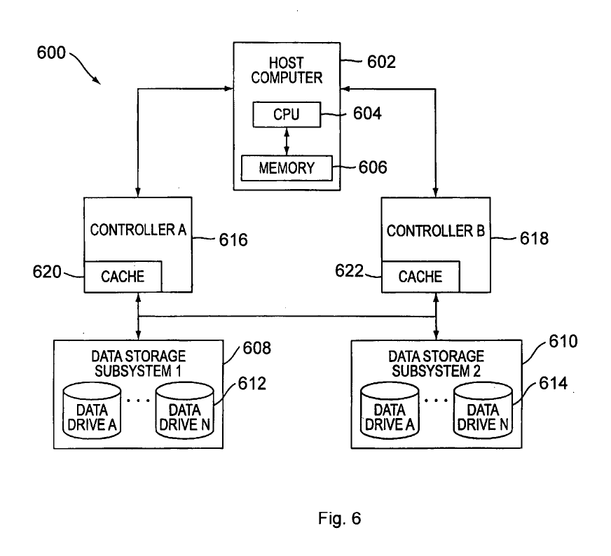

FIG. 6 illustrates a storage system 600 having multiple controllers and RAIDs according to an embodiment of the present invention. In FIG. 6, a host computer 602 with a processor 604 and associated memory 606 is coupled to first and second storage controllers 616, 618. One or more data storage subsystems 608, 610 each having a plurality of hard disk drives 612, 614 are coupled to the first and second storage controllers 616, 618. Storage controllers 616, 618 direct data traffic from the host system to one or more non-volatile storage devices. Storage controllers 616, 618 may or may not have an intermediary cache 620, 622 to stage data between the non-volatile storage device and the host system. The cache 620, 622 are used to stage data between the non-volatile storage devices 612, 614 and the host system 602. Furthermore, cache 620, 622 may also act as a buffer in which to allow exclusive—or (XOR) operations to be completed for RAID 5 operations. Each controller 616, 618 may control its own RAID. If controller A 616 fails, the writes that are in progress are mirrored to alternate controller 618 to accelerate resynchronization according to an embodiment of the present invention.

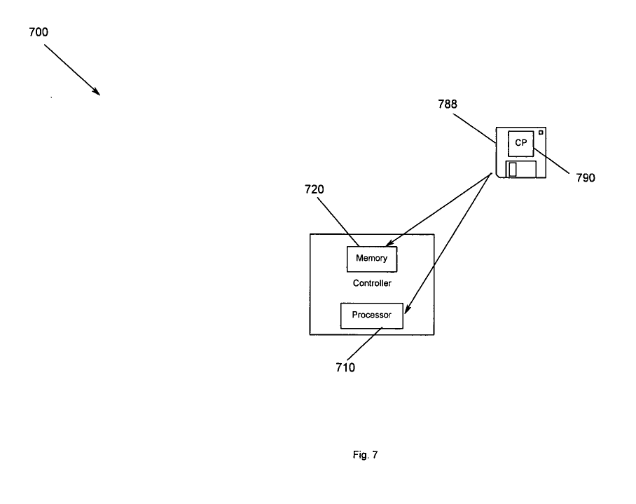

FIG. 7 illustrates a component or system 700 is a high availability storage system according to an embodiment of the present invention. The system 700 includes a processor 710 and memory 720. The processor controls and processes data for the storage controller 700. The process illustrated with reference to FIGS. 1-6 may be tangibly embodied in a computer-readable medium or carrier, e.g. one or more of the fixed and/or removable data storage devices 788 illustrated in FIG. 7, or other data storage or data communications devices. The computer program 790 may be loaded into memory 720 to configure the processor 710 for execution. The computer program 790 include instructions which, when read and executed by a processor 710 of FIG. 7 causes the processor 710 to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

1. A method for minimizing time for resynchronizing RAID stripes on failover, comprising:
handling writes to a stripe in storage devices arranged at least in part in a RAID 5 configuration using a first controller;
mirroring the writes to a second controller during the writing to storage devices by the first controller; and
resynchronizing only writes in progress when the first controller fails.

2. The method of claim 1, wherein the resynchronizing only writes in progress further comprises performing exclusive OR operations with the new data of writes in progress with existing data in the stripe to produce new consistent parity.

3. The method of claim 2, wherein the performing exclusive OR operations with the new data of writes in progress further comprises using the data mirrored in the second controller to produce new consistent parity.

4. The method of claim 1, wherein the resynchronizing only writes in progress further comprises using the data mirrored in the second controller to produce new consistent parity.

5. A storage system, comprising:
a first controller;
a second controller;
at least one storage subsystem, the storage subsystem having at least a portion configured in a RAID 5 configuration; and
wherein the first controller handles a write operation to a stripe in the at least one storage subsystem and the second controller mirrors the write operation during the writing to the at least one storage subsystem by the first controller and the second controller, when the first controller fails, resynchronizes only writes in progress.

6. The storage system of claim 5, wherein the second controller resynchronizes only writes in progress by performing exclusive OR operations with the new data of writes in progress with existing data in the stripe to produce new consistent parity.

7. The storage system of claim 6, wherein the second controller performs exclusive OR operations with the new data of writes in progress using the data mirrored in the second controller to produce new consistent parity.

8. The storage system of claim 5, wherein the second controller uses the data mirrored in the second controller to produce new consistent parity.

9. A controller, comprising:
memory for storing data therein; and
a processor, coupled to the memory, for processing data, the processor mirrors write operations to at least one storage subsystem by another controller, the processor, when the other controller fails, resynchronizes only writes in progress.

10. The controller of claim 5, wherein the processor resynchronizes only writes in progress by performing exclusive OR operations with the new data of writes in progress with existing data in the stripe to produce new consistent parity.

11. The controller of claim 6, wherein the processor performs exclusive OR operations with the new data of writes in progress using the mirrored data to produce new consistent parity.

12. The controller of claim 5, wherein the processor uses the mirrored data to produce new consistent parity.

13. A program storage device, comprising:
program instructions executable by a processing device to perform operations for minimizing time for resynchronizing RAID stripes on failover, the operations comprising:
handling writes to a stripe in storage devices arranged at least in part in a RAID 5 configuration using a first controller;
mirroring the writes to a second controller during the writing to storage devices by the first controller; and
resynchronizing only writes in progress when the first controller fails.

14. The program storage device of claim 1, wherein the resynchronizing only writes in progress further comprises performing exclusive OR operations with the new data of writes in progress with existing data in the stripe to produce new consistent parity.

15. The program storage device of claim 2, wherein the performing exclusive OR operations with the new data of writes in progress further comprises using the data mirrored in the second controller to produce new consistent parity.

16. The program storage device of claim 1, wherein the resynchronizing only writes in progress further comprises using the data mirrored in the second controller to produce new consistent parity.

17. A storage system, comprising:
first means for controlling operations of at least one storage subsystem;
second means for controlling operations of at least one storage subsystem; and
at least one storage subsystem, the storage subsystem having at least a portion configured in a RAID 5 configuration;
wherein the first means handles a write operation to a stripe in the at least one storage subsystem and the second means mirrors the write operation during the writing to the at least one storage subsystem by the first means and the second means, when the first means fails, resynchronizes only writes in progress.

18. A controller, comprising:
means for storing data; and
means, coupled to the means for storing data, for processing data, the means for processing data mirroring write operations to at least one storage subsystem by another means for processing, the means for processing when the other means for processing fails, resynchronizes only writes in progress.
